(19) United States
(12) Patent Application Publication
(10) Pub. No.: US 2025/0153406 A1
(43) Pub. Date: May 15, 2025

(54) ARTICLE MANUFACTURING METHOD AND MANUFACTURING APPARATUS

(71) Applicant: CANON KABUSHIKI KAISHA, Tokyo (JP)

(72) Inventors: RYO SATO, Kanagawa (JP); YUKUO YAMAGUCHI, Tokyo (JP); SHUICHI HASEGAWA, Kanagawa (JP); TOMOAKI KAMAGATA, Kanagawa (JP); DAIKI YAMAMOTO, Kanagawa (JP); TOSHIYUKI TOMITA, Kanagawa (JP); KAZUNORI SUZUKI, Saitama (JP); MOTOHIRO WATANABE, Saitama (JP); Kazunori Iimura, Ibaraki (JP); SATOSHI KAYABA, Ibaraki (JP)

(21) Appl. No.: 18/914,525

(22) Filed: Oct. 14, 2024

(30) Foreign Application Priority Data
Nov. 9, 2023 (JP) 2023-191428

(51) Int. Cl. B29C 45/26; B29C 45/00; B29C 45/04; B29C 45/40

(52) U.S. Cl. CPC B29C 45/2681; B29C 45/0062; B29C 45/045; B29C 45/40

(57) ABSTRACT

There are provided an article manufacturing method and a manufacturing apparatus capable of removing a molded article from an intermediate mold in an injection molding machine. For this purpose, the intermediate mold disposed between the first and second molds in the injection molding machine is provided with a removal mechanism for removing the molded article.

### BACKGROUND

### Field

The present disclosure relates to an article manufacturing method and a manufacturing apparatus.

### Description of the Related Art

Japanese Patent Laid-Open No. 2011-230345 discusses a method of providing a rotatable intermediate mold between a first mold and a second mold of an injection molding machine, performing primary molding with the first mold and the intermediate mold to form a molded article, then rotating the intermediate mold 180° with the molded article left in the intermediate mold, performing secondary molding with the second mold and the intermediate mold, and then removing a molded article from the second mold.

Depending on a product, the molded article left in the intermediate mold may need to be removed after the primary molding is finished and the molds are opened. In the method of Japanese Patent Laid-Open No. 2011-230345, however, the molded article left in the intermediate mold cannot be removed after the molds are opened.

### SUMMARY

Thus, the present disclosure provides an article manufacturing method and a manufacturing apparatus capable of removing a molded article from an intermediate mold in an injection molding machine.

An aspect of the present disclosure provided an article manufacturing method that includes a first molding step of performing molding with a first mold and an intermediate mold; a rotating step of rotating the intermediate mold; an intermediate removing step of removing a molded article molded in the first molding step from the intermediate mold; and a second molding step of performing molding with a second mold and the intermediate mold.

Another aspect of the present disclosure provides a manufacturing apparatus that includes a first mold; a second mold; an intermediate mold provided between the first mold and the second mold, the intermediate mold including a first plurality of surfaces capable of mold clamping with the first mold and a second plurality of surfaces capable of mold clamping with the second mold, and a removal mechanism configured to remove a molded article from the intermediate mold.

Further features of the present disclosure will become apparent from the following description of exemplary embodiments with reference to the attached drawings.

### BRIEF DESCRIPTION OF THE DRAWINGS

FIG. 1 is a schematic diagram of an injection molding apparatus;

FIGS. 2A to 2C are configuration diagrams showing a conventional eject apparatus and injection molding apparatus;

FIG. 3 is a diagram showing an injection molding apparatus with an elevating and lowering apparatus provided at the bottom;

FIG. 4 is a diagram showing an intermediate mold and the elevating and lowering apparatus provided at the bottom of the intermediate mold;

FIGS. 5A to 5D are diagrams showing knock-out operation in the elevating and lowering apparatus;

FIGS. 6A and 6B are diagrams showing a connection state between the intermediate mold and the elevating and lowering apparatus in the injection molding apparatus;

FIGS. 7A to 7F are diagrams showing a first molded article and a second molded article in a second step and a third step;

FIGS. 8A to 8E are diagrams showing an example of removing a molded article from a predetermined position on each surface of the intermediate mold;

FIG. 9 is an overall view showing an inkjet printer;

FIGS. 10A to 10C are diagrams showing a liquid container;

FIGS. 11A to 11C are diagrams showing a method of manufacturing a connecting member; and

FIGS. 12A to 12C are cross-sectional views showing a first molded article, a second molded article, and a third molded article.

### DESCRIPTION OF THE EMBODIMENTS

Embodiments of this disclosure will be described below with reference to the drawings.

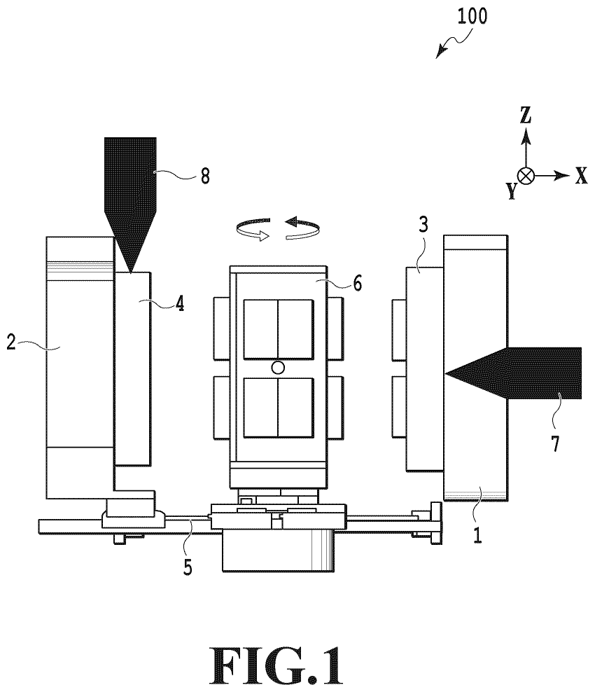

FIG. 1 is a schematic diagram of an injection molding apparatus 100 according to the present embodiment. The injection molding apparatus 100 comprises a first mold 3 attached to a fixed platen 1 and a second mold 4 attached to a movable platen 2. The second mold 4 is configured to move in an X direction (mold moving direction). The injection molding apparatus 100 further comprises an intermediate mold 6 provided along an LM (linear motion) guide 5 between the first mold 3 and the second mold 4, and configured to rotate about a rotation axis extending in a Z direction substantially orthogonal to the X direction, which is the moving direction of the second mold 4. The injection molding apparatus 100 further comprises an injection unit 7 for the first mold 3 and an injection unit 8 for the second mold 4. The LM guide (support member) 5 extends in the X direction and supports the second mold 4 and the intermediate mold 6. The intermediate mold 6 rotates about an axis orthogonal to a support surface of the LM guide.

The second mold 4 is configured to move in the X direction together with the intermediate mold 6 and perform mold clamping. In molding, primary molding is first performed by clamping the first mold 3 and the intermediate mold 6, and injecting molten resin from the injection unit 7. The molds are then opened. At this time, the molds are adjusted so that a first molded article produced by the primary molding is left in the intermediate mold 6.

The intermediate mold 6 is then rotated 180° so that the first molded article that is left in the intermediate mold 6 is positioned to face the second mold 4. Next, the molds are clamped again, primary molding of a second molded article is performed in the first mold 3, and secondary molding of the first molded article is performed in the second mold 4 by injecting molten resin from the injection unit 8.

Although it has been explained that the second mold 4 and the intermediate mold 6 move for mold clamping, the configuration is not so limited to this; at least because the first mold 3 and the second mold 4 may instead move toward the intermediate mold 6.

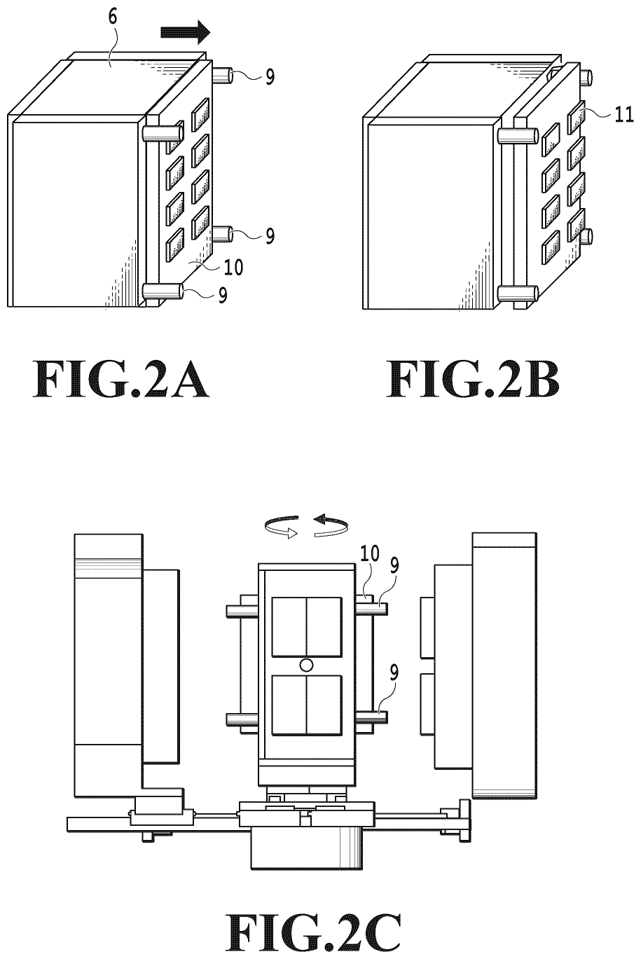

FIGS. 2A to 2B are diagrams shown as a comparative example and are configuration diagrams showing a conventional eject apparatus and an injection molding apparatus comprising the conventional eject apparatus in an intermediate mold. FIGS. 2A and 2B shows the conventional eject apparatus before and after removal of a molded article. FIG. 2C shows the injection molding apparatus with the conventional eject apparatus incorporated as a part of, i.e., within, the intermediate mold.

To provide an eject apparatus in an intermediate mold, the conventional eject apparatus may be provided in the intermediate mold, as shown in FIG. 2C. The conventional eject apparatus drives cylinders or the like in a direction of removal of a molded article as shown in FIGS. 2A and 2B to move an eject plate in the direction of removal of the molded article and remove the molded article. However, in the conventional method of removing the molded article by driving the cylinders or the like in the direction of removal of the molded article, the thickness and weight of the intermediate mold may increase and the injection molding apparatus may be upsized. Accordingly, the present embodiment will describe a manufacturing apparatus capable of removing a molded article from an intermediate mold while suppressing upsizing of the manufacturing apparatus.

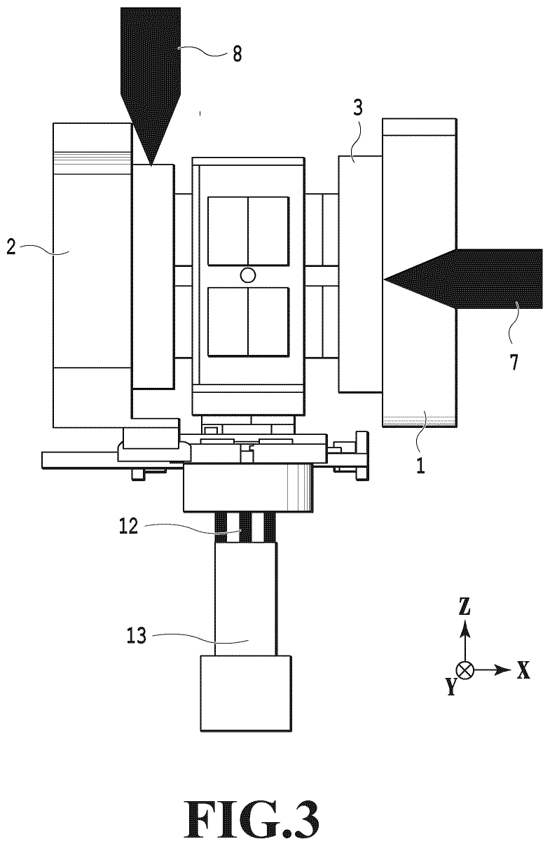

FIG. 3 is a diagram showing the injection molding apparatus 100 according to the present embodiment with an elevating and lowering apparatus 13 provided in the intermediate mold 6. In the injection molding apparatus 100 according to the present embodiment, the intermediate mold 6 can be rotated by 90°. A description will be given of a case where the intermediate mold 6 is rotated by 90°. The intermediate mold 6 comprises four surfaces used for molding and rotates by 90°. The intermediate mold 6 performs molding that includes rotating to change surfaces facing the first mold 3 and the second mold 4.

In a first step of molding, the injection unit 7 injects molten resin between the first mold 3 and the intermediate mold 6 to mold a molded article (primary molding). Molds in different shapes may be arranged in the same surface to form different types of molded articles. Although it has been explained that the intermediate mold 6 comprises four surfaces used for molding, the intermediate mold 6 is not limited to this and may comprise more surfaces such as six surfaces.

After the molds are opened, the process transitions to a second step by rotating the intermediate mold 6 by 90° while maintaining, i.e., leaving, the molded article in the intermediate mold 6. Although the intermediate mold 6 rotates about an axis extending in the Z direction in FIG. 3, the intermediate mold 6 may rotate about a horizontal axis (such as a Y axis). This is basically adopted in a case where the intermediate mold 6 rotates by 180° to perform processing while facing the first mold 3 and the second mold 4 because the second step is performed with the intermediate mold 6 being in a vertical position.

In the second step, it is considered that a six-axis robot or the like is used to insert a different type of member such as a filter or a rubber part into the molded article or remove the molded article and attach it to a molded article in a different, adjacent mold on the same surface. In the case of attachment, the molded article needs to be removed from the intermediate mold 6 in order for the six-axis robot or the like to remove the finished molded article.

A method of removing the molded article from the intermediate mold 6 (intermediate removal) will be described.

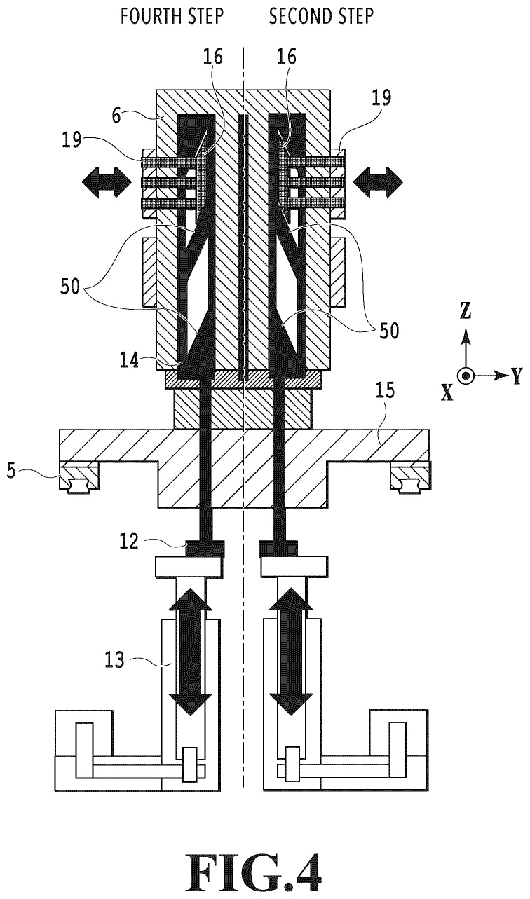

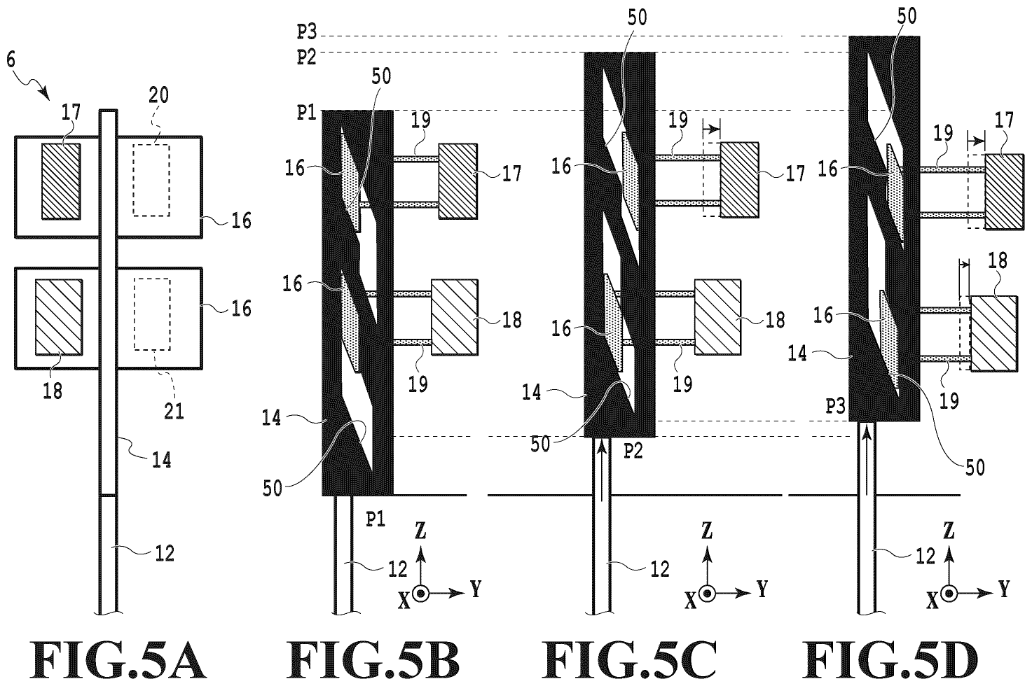

FIG. 4 is a diagram showing the intermediate mold 6 and the elevating and lowering apparatus 13 provided at the bottom of the intermediate mold 6. FIGS. 5A to 5D are diagrams showing a knock-out operation in the elevating and lowering apparatus 13. In the injection molding apparatus 100 according to the present embodiment, the elevating and lowering apparatus 13 having a driver such as a servomotor abuts on an eject rod 12 of the intermediate mold 6 to move the eject rod 12 in a vertical direction corresponding to the direction of the rotation axis of the intermediate mold, i.e., the Z direction. The eject rod 12 is connected to a cam plate 14 of the intermediate mold 6 and the cam plate 14 is combined with an eject plate 16 to which an eject pin 19 is attached. The cam plate 14 has inclined portions 50 and is configured such that the eject plate 16 moves along the inclination of the inclined portions 50. With this configuration, vertical movement of the cam plate 14 caused by movement of the eject rod 12 in the vertical direction, i.e., an elevating and lowering operation, is converted into movement of the eject plate 16 in the horizontal direction which is the Y direction. This enables the eject pin 19 to move and to eject the molded article in the Y direction. Further, by adjusting the positional relationship between the cam plate 14 and the eject plate 16, a molded article at a predetermined position can be removed according to an elevating and lowering position.

As described above, since the cam plate 14 has the inclined portions 50 and vertical movement of the cam plate 14 is converted into movement of the eject plate 16 in the horizontal direction which is the Y direction, the increase in thickness and weight of the intermediate mold can be suppressed and the injection molding apparatus can be downsized.

The knock-out operation, i.e., ejection, by the elevating and lowering apparatus 13 will be described in detail with reference to FIGS. 5A to 5D. FIG. 5A is a diagram showing the positional relationship among a first molded article 17, a second molded article 18, the eject plate 16, and the cam plate 14. In a case where the cam plate 14 moves from a position P1 (see FIG. 5B) which is an initial position to a position P2 (see FIG. 5C), only the first molded article 17 associated with the upper part of the cam plate 14 is knocked out. In a case where the cam plate 14 further moves to a position P3 (see FIG. 5D), the second molded article 18 associated with the lower part of the cam plate 14 is knocked out. Similarly, a third molded article and a fourth molded article may be associated with the eject plate 14; for example, the first molded article and the third molded article may be removed in the second step and attached to the second molded article and the fourth molded article in the subsequent step. In this manner, the elevating and lowering apparatus is configured to stop at different positions.

The elevating and lowering apparatus 13 may stay connected to the eject rod 12 of the intermediate mold 6. In this case, however, since the elevating and lowering apparatus 13 should be rotated with the rotation of the intermediate mold 6, there is a possibility of interference with other parts. Further, since the weight of the intermediate mold 6 increases, the inertial force also increases at the time of rotational movement, which may cause an increase in load on a holding portion of the molded article. Thus, the elevating and lowering apparatus 13 is configured to be separated from the eject rod 12 of the intermediate mold 6.

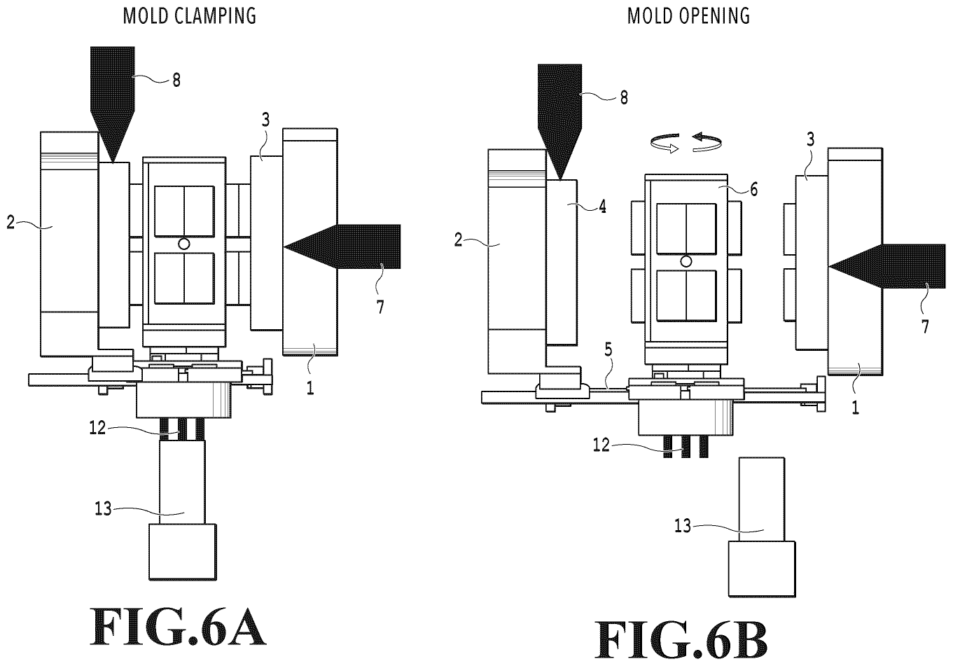

FIGS. 6A and 6B are diagrams showing a connection state between the intermediate mold 6 and the elevating and lowering apparatus 13 in the injection molding apparatus 100; FIG. 6A shows a connection state and FIG. 6B shows a disconnection state. As shown in FIG. 6A, the injection molding apparatus 100 is in the connection state at the time of mold clamping and in the disconnection state at the time of mold opening. Further, since removal from each surface of the intermediate mold 6 is possible, removal from each surface can be performed by the single elevating and lowering apparatus 13 regardless of which surface is positioned in the second step.

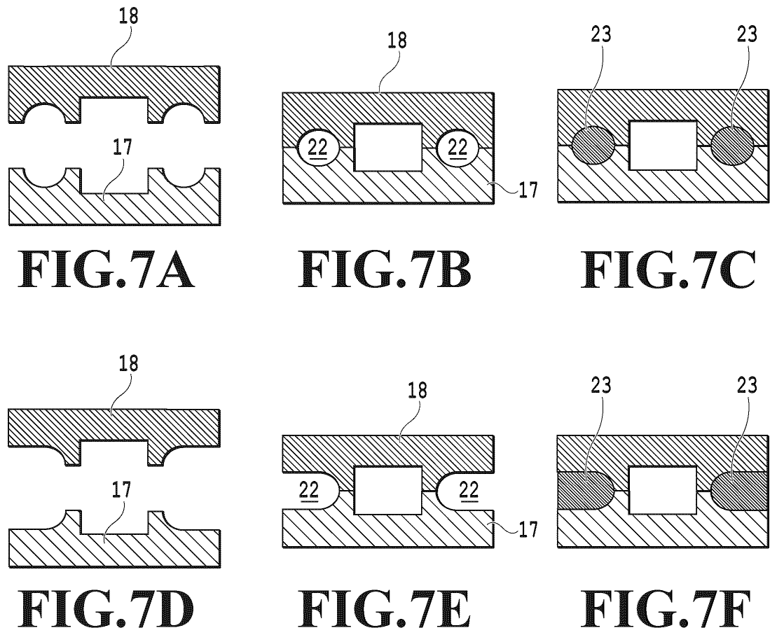

FIGS. 7A to 7F are diagrams showing the first molded article 17 and the second molded article 18 in the second step and the third step. In the second step, the first molded article 17 molded in the first step is removed from the intermediate mold 6 (see FIG. 7A) and attached to the second molded article 18 (see FIG. 7B). The intermediate mold 6 is then rotated 90°. In the third step, molten resin 23 is injected into the first molded article 17 and the second molded article 18 which are attached to each other as shown in FIG. 7C. More specifically, the first molded article 17 and the second molded article 18 are joined together by pouring the molten resin 23 into spaces 22 formed by the first molded article 17 and the second molded article 18.

The spaces 22 are not necessarily formed by combination of molded articles and may be formed by molded articles and molds. In the first molded article 17 and the second molded article 18 shaped as shown in FIGS. 7D to 7F, the spaces 22 are formed by molded articles and molds. The first molded article 17 and the second molded article 18 may be thus joined together by pouring the molten resin 23 into the spaces 22 formed by molded articles and molds. Further, so-called double molding may be performed, where a molded article obtained by primary molding in the first step is subjected to secondary molding using a different material in the third step.

Next, the intermediate mold 6 is further rotated 90°. In a fourth step, the molded article is removed from the intermediate mold 6. Also in this step, a molded article at a predetermined position is removed from each surface of the intermediate mold 6 with the elevating and lowering apparatus 13 provided at the bottom of the intermediate mold 6 as in the second step. As described above, since the elevating and lowering apparatus 13 and the eject plate 14 are multistage, a molded article at a predetermined position on each surface may be removed at arbitrary timing depending on a position.

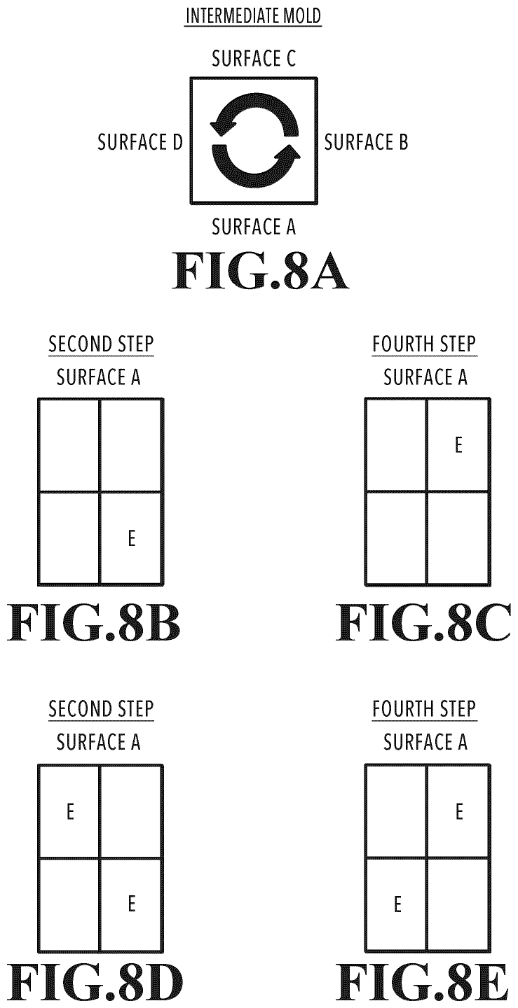

FIGS. 8A to 8E are diagrams showing an example of removing a molded article from a predetermined position on each surface of the intermediate mold 6. As shown in FIG. 8A, the four surfaces of the intermediate mold 6 are defined as surface A, surface B, surface C, and surface D. Surfaces A to D move with the rotation of the intermediate mold 6. That is, for example, the surface A proceeds from the first step via the second and third steps to the fourth step. Further, each of the surfaces A to D is divided into quarters and a mold of varied type may be attached to any quarter. In FIGS. 8B to 8E, “E” indicates a place to remove (eject) a molded article. Although the steps are simultaneously performed in the injection molding apparatus 100 according to the present embodiment, (the upper and lower molds on the right of) the surface A will be described in order of steps to completion of one molded article and description of the surfaces other than the surface A are omitted, for conciseness.

In the first step, primary molding is performed using the surface A to mold a first molded article 17 in an upper right mold in a quarter of the surface A and mold a second molded article 18 in a lower right mold (see the mold shown by “E” in FIG. 8B). After that, the intermediate mold 6 is rotated 90°. In the second step, the second molded article 18 in the lower right mold molded in the primary molding is removed (ejected) by elevating or lowering the elevating and lowering apparatus 13 to a predetermined position and attached to the first molded article 17 in the upper right mold. The intermediate mold 6 is then further rotated 90°. In the third step, molten resin is injected to join (weld) the first molded article 17 and the second molded article 18. After that, the intermediate mold 6 is rotated 90°. In the fourth step, the elevating and lowering apparatus 13 is moved to a position higher than that in the second step and the molded article in the upper right mold (the article obtained by joining the first molded article 17 and the second molded article 18) is removed.

Further, different types of articles can be molded by performing the same operation as the right molds also in upper and lower molds on the left of the surface A (in the drawings, the upper and lower molds are inverted on the right and left).

Although the method of removing the molded article from the intermediate mold 6 in a case where the intermediate mold 6 rotates has been described, this disclosure is effective also in a case where the intermediate mold 6 does not rotate. For example, this disclosure is useful also in a case where molded articles left in the intermediate mold need to be removed after mold opening in a so-called stack mold or in a case where molds are opened while knocking a molded article out of the intermediate mold so that the molded article is reliably left in the first or second mold.

A description will be given of an inkjet printer using a connecting member manufactured by the use of the injection molding apparatus 100 according to the present embodiment.

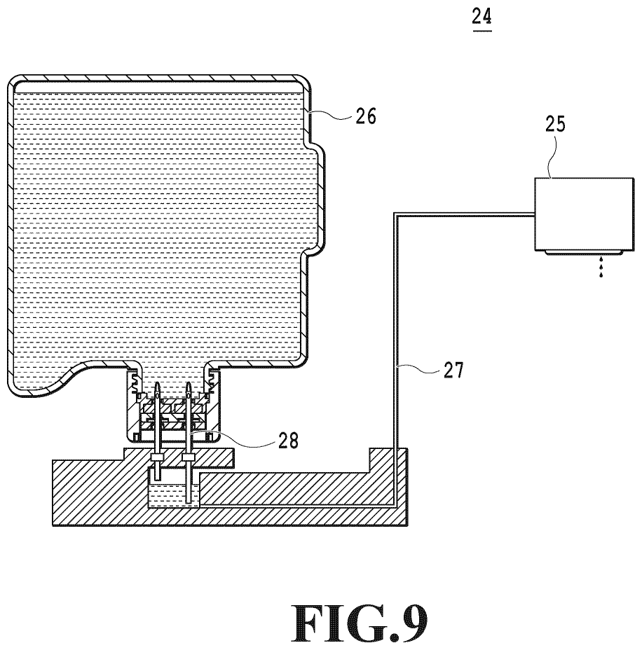

FIG. 9 is an overall view showing an inkjet printer 24. In the inkjet printer 24, a liquid container 26 storing liquid and an inkjet print head 25 communicate with each other through a tube 27 and a hollow needle 28. In this inkjet printer 24, for example, the injection molding apparatus 100 is useful in producing a connecting member 32 used for a connecting portion of the liquid container 26.

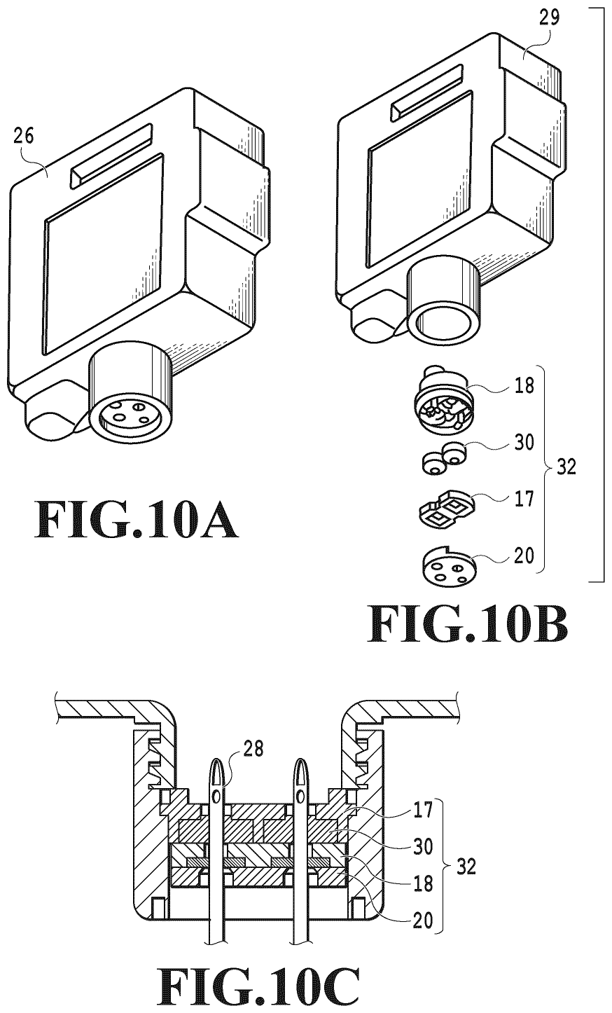

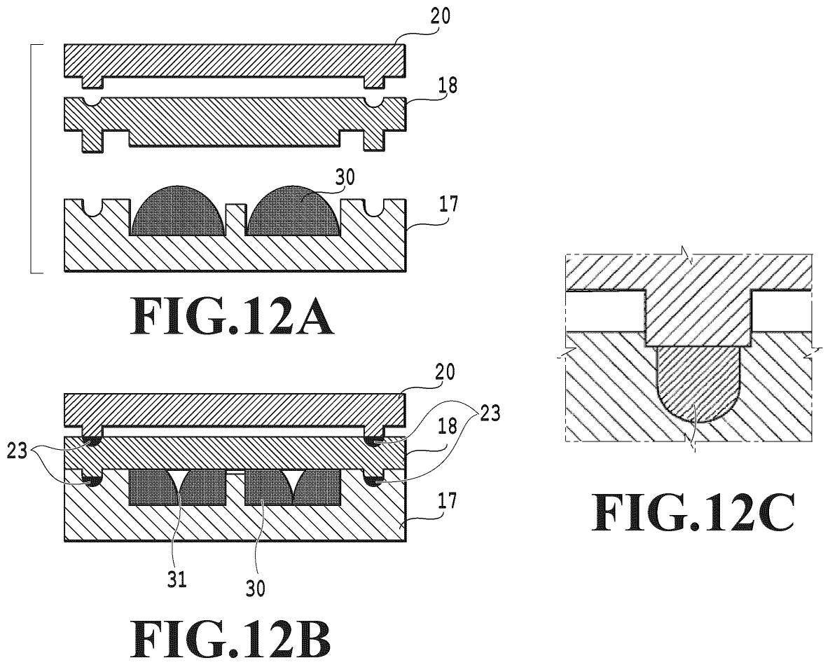

FIGS. 10A to 10C are diagrams showing the liquid container 26; FIG. 10A shows an external view, FIG. 10B shows an exploded perspective view, and FIG. 10C shows a partial enlarged view of the connecting portion. The liquid container 26 comprises a liquid containing portion 29 and the connecting member 32. The connecting member 32 comprises the first molded article 17, an elastic member 30, the second molded article 18, and a third molded article 20. The connecting member 32 provides a function of a valve capable of storing and supplying liquid by insertion of the hollow needle 28 into the elastic member 30 with a break (break 31 shown in FIG. 12B described later).

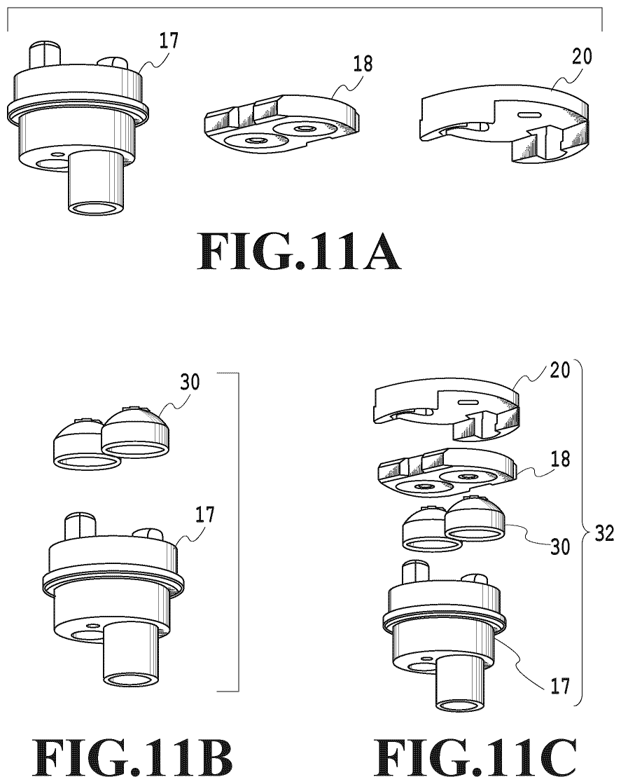

FIGS. 11A to 11C are diagrams showing a method of manufacturing the connecting member 32. In the present embodiment, the first molded article 17, the second molded article 18, and the third molded article 20 are formed by injection molding using the injection molding apparatus 100 (see FIG. 11A). After that, the elastic member 30 is supplied to the first molded article 17 (see FIG. 11B) and the second molded article 18 and the third molded article 20 are attached thereon and joined together (see FIG. 11C). That is, the first molded article 17, the second molded article 18, and the third molded article 20 are molded by primary molding in the first step, the elastic member 30 is supplied to the first molded article 17 in the intermediate mold 6 in the second step, and the second molded article 18 and the third molded article 20 are attached thereon. Next, the first molded article 17, the second molded article 18, and the third molded article 20 are joined together by secondary molding in the third step and the completed connecting member 32 is removed from the intermediate mold 6 in the fourth step. The connecting member 32 can be manufactured by the above series of steps.

FIGS. 12A to 12C are cross-sectional views showing the first molded article 17, the second molded article 18, and the third molded article 20 in the joining step. In joining in the fourth step, the molten resin 23 is poured into spaces formed by the molded articles to obtain an integrated molded article. In a case where the molten resin 23 is poured into the spaces, the molded articles are properly in pressure contact with each other while compressing the elastic member 30 using a clamping force so that the molded articles are stably held until injection and cooling of the molten resin 23. This also removes the necessity for additional equipment for compression.

As described above, the intermediate mold in the injection molding machine comprises a molded article removal mechanism. Accordingly, an article manufacturing method and a manufacturing apparatus capable of removing a molded article from the intermediate mold in the injection molding machine can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-191428 filed Nov. 9, 2023, which is hereby incorporated by reference wherein in its entirety.

What is claimed is:

1. An article manufacturing method comprising:
a first molding step of performing molding with a first mold and an intermediate mold;
a rotating step of rotating the intermediate mold;
an intermediate removing step of removing a molded article molded in the first molding step from the intermediate mold; and
a second molding step of performing molding with a second mold and the intermediate mold.

2. The article manufacturing method according to claim 1, wherein each of the first molding step and the second molding step comprises:
performing mold clamping by moving the second mold and the intermediate mold in a mold moving direction; and
performing mold opening by moving the second mold and the intermediate mold in the mold moving direction, and
wherein, in the rotating step, the intermediate mold rotates about a rotation axis orthogonal to the mold moving direction.

3. The article manufacturing method according to claim 2, further comprising, prior to the first molding step:
arranging the first mold and the second mold with the intermediate mold therebetween; and
supporting the second mold and the intermediate mold by a support member,
wherein the support member extends in the mold moving direction.

4. The article manufacturing method according to claim 3, wherein in the rotating step, the intermediate mold is rotated about an axis orthogonal to a surface supporting the intermediate mold.

5. The article manufacturing method according to claim 1, wherein in the rotating step, the intermediate mold is rotated by 90° relative to the first mold and the second mold.

6. The article manufacturing method according to claim 4, wherein in the intermediate removing step, the molded article is removed from the intermediate mold by an elevating and lowering apparatus in an axial direction relative to the rotation axis.

7. The article manufacturing method according to claim 6, wherein the elevating and lowering apparatus abuts an eject rod in the intermediate mold and is configured to elevate and lower the eject rod.

8. The article manufacturing method according to claim 7, further comprising a cam plate having an inclined portion,
wherein the a cam plate is provided in the intermediate mold, and is moved by elevating and lowering of the eject rod.

9. The article manufacturing method according to claim 8, further comprising an eject pin configured to move in the mold moving direction, to eject the molded article in response to movement of an eject plate along the inclined portion of the cam plate.

10. The article manufacturing method according to claim 6, wherein in the intermediate removing step, the elevating and lowering apparatus is configured to stop at different elevations.

11. The article manufacturing method according to claim 1, wherein in the intermediate removing step, a plurality of molded articles are removed from the intermediate mold.

12. The article manufacturing method according to claim 7, wherein the elevating and lowering apparatus is configured be separated from the eject rod.

13. The article manufacturing method according to claim 1, wherein the molding performed in the first molding step uses a first material and the molding performed the second molding step uses a second material that is different from the first material.

14. The article manufacturing method according to claim 1, further comprising:
a final removal step,
wherein, after the molded article is formed in the first molding step, a first molded article in the intermediate mold is removed in the intermediate removing step and is attached to a second molded article in the intermediate mold,
wherein the second molding step further comprises welding the first molded article to the second molded article, and
wherein the final removal step includes removing the welded first molded article and second molded article from the intermediate mold.

15. A manufacturing apparatus, comprising:
a first mold;
a second mold;
an intermediate mold provided between the first mold and the second mold, the intermediate mold including a first plurality of surfaces capable of mold clamping with the first mold and a second plurality of surfaces capable of mold clamping with the second mold, and
a removal mechanism configured to remove a molded article from the intermediate mold.

16. The manufacturing apparatus according to claim 15, wherein:
the second mold and the intermediate mold are each configured to perform mold clamping and mold opening with the first mold by moving in a mold moving direction, and
the intermediate mold is configured to rotate about a rotation axis orthogonal to the mold moving direction.

17. The manufacturing apparatus according to claim 16, wherein the second mold and the intermediate mold are supported by a support member extending in the mold moving direction.

18. The manufacturing apparatus according to claim 15, wherein the intermediate mold is configured to rotate about an axis orthogonal to a surface supporting the intermediate mold.

19. The manufacturing apparatus according to claim 15, wherein the intermediate mold is configured to rotate by 90° relative to the first mold and the second mold.

20. The manufacturing apparatus according to claim 18, wherein a molded article is removed from the intermediate mold by an elevating and lowering apparatus in an axial direction relative to the rotation axis.
